(19) United States
(12) Patent Application Publication
(10) Pub. No.: US 2016/0347121 A1
(43) Pub. Date: Dec. 1, 2016

(54) MULTILAYER LAMINATE FOR A TIRE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: MARC GREIVELDINGER, CLERMONT-FERRAND (FR); EMMANUEL CUSTODERO, CLERMONT-FERRAND (FR); CHRISTOPHE CHOUVEL, CLERMONT-FERRAND (FR)

(21) Appl. No.: 15/114,506

(22) PCT Filed: Jan. 27, 2015
(86) PCT No.: PCT/EP2015/051589

§ 371 Date: Jul. 27, 2016

(30) Foreign Application Priority Data
Jan. 28, 2014 (FR) 1450669

(51) Int. Cl. B60C 1/00; C08L 9/06; C08L 53/02

(52) U.S. Cl. CPC B60C 1/0016; C08L 53/025; C08L 9/06

(57) ABSTRACT

An elastomeric laminate for tires comprises at least two superimposed layers of elastomer. The first layer is composed of a composition based on at least one thermoplastic elastomer (TPE), said thermoplastic elastomer being a block copolymer comprising at least one optionally hydrogenated butadiene/styrene random copolymer-type elastomer block and at least one styrene-type thermoplastic block, at a content within a range extending from more than 50 to 100 phr (parts by weight per 100 parts by weight of elastomer). The second layer is composed of a composition based on at least one diene elastomer, the content of diene elastomer being within a range extending from more than 50 to 95 phr, and on at least one thermoplastic elastomer (TPE), said thermoplastic elastomer being a block copolymer comprising at least one optionally hydrogenated butadiene-styrene random copolymer-type elastomer block and at least one styrene-type thermoplastic block, at a content within a range extending from 5 to less than 50 phr.

The present invention relates to laminates for tyres comprising a composition, the elastomers of which are predominantly thermoplastic elastomers (TPEs), in one of their elastomeric layers.

In a conventional tyre, the various elastomeric layers are composed of diene elastomer compositions, adhering to one another via bonds created during the crosslinking of said elastomers. These layers thus have to be combined before curing (or crosslinking) in order to allow them to adhere.

It is advantageous today for tyre manufacturers to use elastomeric layers comprising, as elastomers, predominantly thermoplastic elastomers (TPEs) in order to benefit from the properties of these elastomers, especially for the reduction in the rolling resistance and the processability. Such thermoplastic elastomer layers are described, for example, in document WO2012/152686.

The difficulty in the use of such layers, the elastomers of which are predominantly TPEs, is their adhesion to the adjacent diene layers of conventional composition before the curing of the resulting laminate or after the curing of the layer adjacent to the layer, the elastomers of which are predominantly TPEs.

In order to improve this adhesion, the applicants have previously described laminates for tyres comprising a layer, the elastomers of which are predominantly thermoplastic elastomers (TPEs), for example in the document WO2010/063427. In this document, the layer predominantly composed of TPE can adhere to a diene layer by the presence of a specific intermediate adhesive layer. While it is effective, the resulting laminate adds an additional layer to the structure of the tyre, which makes it heavier and adds a step to the manufacture thereof.

With the aim of improving conventional tyres by the use of a layer predominantly based on a TPE elastomer, while simplifying the adhesion of such a layer to an adjacent crosslinked or non-crosslinked diene layer, the applicant has found, surprisingly, the laminate of the invention.

A subject-matter of the invention is thus an elastomeric laminate for tyres, said laminate comprising at least two adjacent layers of elastomer:
a first layer, composed of a composition based on at least one thermoplastic elastomer (TPE), said thermoplastic elastomer being a block copolymer comprising at least one optionally hydrogenated butadiene/styrene random copolymer-type elastomer block and at least one styrene-type thermoplastic block, at a content within a range extending from more than 50 to 100 phr (parts by weight per 100 parts by weight of elastomer);
a second layer, composed of a composition based on at least one diene elastomer, the content of diene elastomer being within a range extending from more than 50 to 95 phr, and on at least one thermoplastic elastomer (TPE), said thermoplastic elastomer being a block copolymer comprising at least one optionally hydrogenated butadiene/styrene random copolymer-type elastomer block and at least one styrene-type thermoplastic block, at a content within a range extending from 5 to less than 50 phr.

This laminate makes it possible to have a satisfactory adhesion between the two layers of the multilayer laminate of the invention. In comparison with the solutions of the prior art, the invention is of great simplicity, since it makes it possible to dispense with a layer, the only role of which would be the adhesion of the TPE layer to the diene layer, and thus not to make the tyre heavy and thus not to increase its rolling resistance.

Another major advantage of the invention is to make possible a saving in materials since, instead of using an additional elastomeric layer for the adhesion, the invention makes it possible for a predominantly diene layer (like the compositions of conventional tyres) to adhere to a thermoplastic elastomer layer. This saving is furthermore highly favourable to environmental conservation.

Preferably, the invention relates to a laminate as defined above, in which the number-average molecular weight of the thermoplastic elastomers is between 30 000 and 500 000 g/mol.

Also preferably, the invention relates to a laminate as defined above, in which the elastomer blocks of the thermoplastic elastomers are selected from elastomers having a glass transition temperature of less than 25° C. Preferentially, the SBR elastomer block(s) have a styrene content within a range extending from 10% to 60%. Also preferentially, the SBR elastomer block(s) have a content of 1,2-bonds for the butadiene part within a range extending from 4 mol % to 75 mol % and a content of 1,4-bonds within a range extending from 20 mol % to 96 mol %.

Preferably, the invention relates to a laminate as defined above, in which the SBR elastomer block(s) of the first layer are hydrogenated such that a proportion extending from 25 mol % to 100 mol %, preferentially from 50 mol % to 100 mol %, and preferably from 80 mol % to 100 mol % of the double bonds in the butadiene portion are hydrogenated.

Also preferably, the invention relates to a laminate as defined above, in which the SBR elastomer block(s) of the second layer are hydrogenated such that a proportion extending from 0 to 80 mol %, preferentially from 20 mol % to 70 mol %, and preferably from 30 mol % to 60 mol % of the double bonds in the butadiene portion are hydrogenated.

Also preferably, the invention relates to a laminate as defined above, in which the thermoplastic styrene block(s) of the block copolymer are selected from polymers having a glass transition temperature of greater than 80° C. and, in the case of a semicrystalline thermoplastic block, a melting point of greater than 80° C. Preferentially, the fraction of thermoplastic styrene block in the block copolymer is within a range extending from 5% to 70%.

Preferentially, the invention relates to a laminate as defined above, in which the thermoplastic block(s) of the block copolymer are selected from polystyrenes, preferably selected from polystyrenes obtained from styrene monomers selected from the group consisting of unsubstituted styrene, methylstyrenes, para-tert-butylstyrene, chlorostyrenes, bromostyrenes, fluorostyrenes, para-hydroxystyrene and mixtures thereof. Preferentially, the thermoplastic block(s) of the block copolymer are selected from polystyrenes obtained from styrene monomers selected from the group consisting of unsubstituted styrene, o-methylstyrene, m-methylstyrene, p-methylstyrene, alpha-methylstyrene, alpha,2-dimethylstyrene, alpha,4-dimethylstyrene, diphenylethylene, para-tert-butylstyrene, o-chlorostyrene, m-chlorostyrene, p-chlorostyrene, 2,4-dichlorostyrene, 2,6-dichlorostyrene, 2,4,6-trichlorostyrene, o-bromostyrene, m-bromostyrene, p-bromostyrene, 2,4-dibromostyrene, 2,6-dibromostyrene, 2,4,6-tribromostyrene, o-fluorostyrene, m-fluorostyrene, p-fluorostyrene, 2,4-difluorostyrene, 2,6-difluorostyrene, 2,4,6-trifluorostyrene, para-hydroxystyrene and mixtures thereof. More preferentially, the thermoplastic block(s) of the block copolymer are obtained from unsubstituted polystyrene.

Preferably, the invention relates to a laminate as defined above, in which the content of the block copolymer thermoplastic elastomer (TPE) comprising at least one optionally hydrogenated butadiene/styrene random copolymer-type elastomer block and at least one styrene-type thermoplastic block in the composition of the first layer is within a range extending from 70 to 100 phr, preferably from 80 to 100 phr.

Preferentially, the invention relates to a laminate as defined above, in which the block copolymer thermoplastic elastomer comprising at least one optionally hydrogenated butadiene/styrene random copolymer-type elastomer block and at least one styrene-type thermoplastic block is the only elastomer of the first layer.

Preferably, the invention relates to a laminate as defined above, in which the first layer does not contain a crosslinking system.

Preferentially, the invention relates to a laminate as defined above, in which the first layer additionally comprises a thermoplastic resin comprising optionally substituted polyphenylene ether units. Preferably, the thermoplastic resin based on optionally substituted polyphenylene ether units has a glass transition temperature (T_{g}), measured by DSC according to standard ASTM D3418, 1999, within a range extending from 0 to 215° C. Also preferably, the thermoplastic resin based on optionally substituted polyphenylene ether units is a compound comprising predominantly polyphenylene units of general formula (I):

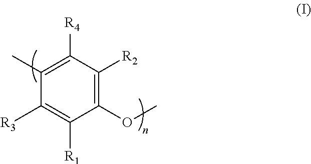

in which:

R₁, R₂, R₃ and R₄ represent, independently of one another, identical or different groups selected from hydrogen, hydroxyl, alkoxy, halogen, amino, alkylamino or dialkylamino groups or hydrocarbon-based groups comprising at least 2 carbon atoms, optionally interrupted by heteroatoms and optionally substituted; R₁ and R₃ on the one hand, and R₂ and R₄ on the other hand, possibly forming, together with the carbon atoms to which they are attached, one or more rings fused to the benzene ring of the compound of formula (I),

n is an integer within a range extending from 3 to 300.

Also preferably, the invention relates to a laminate as defined above. in which R₁ and R₂ represent an alkyl group and in particular a methyl group, and R₃ and R₄ represent hydrogen atoms.

Preferentially, the invention relates to a laminate as defined above, in which the content of said thermoplastic resin based on optionally substituted polyphenylene ether units is within a range extending from 1 to 90 phr, preferably from 2 to 80 phr, more preferentially from 3 to 60 phr and better still from 5 to 60 phr.

Preferably, the invention relates to a laminate as defined above, in which the content of the block copolymer thermoplastic elastomer (TPE) comprising at least one optionally hydrogenated butadiene/styrene random copolymer-type elastomer block and at least one styrene-type thermoplastic block in the composition of the second layer is within a range extending from 5 to 49 phr, more preferentially from 10 to 49 phr.

Also preferably, the invention relates to a laminate as defined above, in which the diene elastomer of the second layer is selected from the group consisting of essentially unsaturated diene elastomers and the mixtures of these elastomers. Preferentially, the diene elastomer is selected from the group consisting of homopolymers obtained by polymerization of a conjugated diene monomer having from 4 to 12 carbon atoms, copolymers obtained by copolymerization of one or more conjugated dienes with one another or with one or more vinylaromatic compounds having from 8 to 20 carbon atoms, and mixtures thereof. More preferentially, the diene elastomer is selected from the group consisting of polybutadienes, synthetic polyisoprenes, natural rubber, butadiene copolymers, isoprene copolymers and the mixtures of these elastomers.

Preferentially, the invention relates to a laminate as defined above, in which the second layer comprises a reinforcing filler; preferably, the reinforcing filler is carbon black and/or silica. Preferentially, the predominant reinforcing filler is silica.

The invention also relates to a tyre comprising a laminate as defined above.

Furthermore, the invention also relates to the use, in a pneumatic object, of a laminate as defined above.

The invention relates more particularly to the laminates as defined above, used in tyres intended to equip non-motor vehicles, such as bicycles, or motor vehicles of passenger vehicle type, SUVs (“Sport Utility Vehicles”), two-wheel vehicles (especially to motorcycles), aircraft, as well as industrial vehicles chosen from vans, “heavy-duty” vehicles—that is to say, underground trains, buses, heavy road transport vehicles (lorries, tractors, trailers) or off-road vehicles, such as agricultural vehicles or vehicles for construction work —, or other transportation or handling vehicles.

The invention and its advantages will be readily understood in light of the description and exemplary embodiments that follow.

### DETAILED DESCRIPTION OF THE INVENTION

In the present description, unless expressly indicated otherwise, all the percentages (%) shown are percentages by weight.

Furthermore, the term “phr” means, within the meaning of the present patent application, parts by weight per hundred parts of elastomer, thermoplastic and diene elastomers mixed together. Within the meaning of the present invention, thermoplastic elastomers (TPEs) are included among the elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

For the requirements of the present invention, it is specified that, in the present patent application, “thermoplastic elastomer layer” or “TPE layer” denotes an elastomeric layer comprising, by weight, a greater amount of thermoplastic elastomer(s) than of diene elastomer(s) and “diene layer” denotes an elastomeric layer comprising, by weight, a greater amount of diene elastomer(s) than of thermoplastic elastomer(s).

The laminate according to the invention exhibits an excellent adhesion between the two layers denoted, for the requirement of clarity of the invention, first and second layers (or respectively thermoplastic elastomer layer and diene layer). Thus, according to the invention, a thermoplastic elastomer layer as defined above can adhere with a diene layer as defined above, by virtue of the presence of a certain amount of TPE with SBR and PS blocks in this diene layer, through the compatibility thereof with the TPE with SBR and PS blocks in the thermoplastic elastomer layer.

The details of the invention will be explained below by the description, firstly, of the possible common constituents of the two layers of the laminate of the invention, then, secondly, by the description of the specific elements of each of the layers of the laminate of the invention and, finally, by the description of the adhesion between the two layers of the laminate according to the invention.

### I—POSSIBLE COMMON CONSTITUENTS OF THE LAYERS OF THE MULTILAYER LAMINATE

The multilayer laminate according to the invention has the essential characteristic of being provided with at least two elastomeric layers referred to as “thermoplastic elastomer layer” and “diene layer” with different formulations, said layers of said multilayer laminate comprising at least one thermoplastic elastomer TPE with SBR and PS blocks as defined below. In addition to the TPE, at least the diene layer also comprises a diene elastomer as defined below.

In addition to the elastomers, the layers of the multilayer laminate of the invention can comprise other non-essential components which are preferentially present or not present, among which mention may especially be made of those which are presented below, with the elastomers discussed above.

### I-1. Specific Thermoplastic Elastomer (TPE) with SBR and PS Blocks

Generally, thermoplastic elastomers (abbreviated to “TPEs”) have a structure intermediate between elastomers and thermoplastic polymers. These are block copolymers composed of rigid thermoplastic blocks connected via flexible elastomer blocks.

For the requirements of the invention, said specific thermoplastic elastomer is a block copolymer comprising at least one optionally hydrogenated butadiene/styrene random copolymer-type (SBR) elastomer block and at least one styrene copolymer-type (PS) thermoplastic block. In the following text, when reference is made to an SBR block, this is therefore an elastomeric block composed predominantly (that is to say to more than 50% by weight, preferably to more than 80% by weight and very preferentially to 100% by weight) of a butadiene/styrene random copolymer, this copolymer possibly being or not being hydrogentated, and when reference is made to a styrene block, this is a block composed predominantly (that is to say to more than 50% by weight, preferably to more than 80% by weight and very preferentially to 100% by weight) of a styrene polymer such as a polystyrene.

1.1.1. Structure of the TPE with SBR and PS blocks

The number-average molecular weight (denoted Mₙ) of the TPE with SBR and PS blocks is preferentially between 30 000 and 500 000 g/mol, more preferentially between 40 000 and 400 000 g/mol. Below the minima indicated, there is a risk of the cohesion between the SBR elastomer chains of the TPE with SBR and PS blocks being affected, especially due to its possible dilution (in the presence of an extending oil); furthermore, an increase in the working temperature risks affecting the mechanical properties, especially the properties at break, with the consequence of a reduced “hot” performance. Furthermore, an excessively high weight Mₙ can detrimentally affect processing. Thus, it has been observed that a value within a range from 50 000 to 300 000 g/mol, better still from 60 000 to 150 000 g/mol, was particularly well suited to a tyre laminate, especially a laminate for a tyre comprising a tyre tread.

The number-average molecular weight (M₂) of the TPE elastomer with SBR and PS blocks is determined in a known way by size exclusion chromatography (SEC). For example, in the case of thermoplastic styrene elastomers, the sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6E), is used. The injected volume of the solution of the polymer sample is 100 μl. The detector is a Waters 2410 differential refractometer, and its associated software for making use of the chromatographic data is the Waters Millennium system. The calculated average molar masses are relative to a calibration curve produced with polystyrene standards. The conditions can be adjusted by by those skilled in the art.

The value of the polydispersity index PI (reminder: PI=M_{w}/Mₙ, with M_{w} the weight-average molecular weight and Mₙ the number-average molecular weight) of the TPE with SBR and PS blocks is preferably less than 3, more preferentially less than 2 and even more preferentially less than 1.5.

In a known way, TPEs with SBR and PS blocks have two glass transition temperature peaks (T_{g}, measured according to ASTM D3418), the lowest temperature being relative to the SBR elastomer part of the TPE with SBR and PS blocks and the highest temperature being relative to the thermoplastic PS part of the TPE with SBR and PS blocks. Thus, the flexible SBR blocks of the TPEs with SBR and PS blocks are defined by a T_{g} which is less than ambient temperature (25° C.), while the rigid PS blocks have a T_{g} which is greater than 80° C.

In the present application, when reference is made to the glass transition temperature of the TPE with SBR and PS blocks, this is the T_{g} relative to the SBR elastomer block. The TPE with SBR and PS blocks preferentially has a glass transition temperature (“T_{g}”) which is preferentially less than or equal to 25° C., more preferentially less than or equal to 10° C. A T_{g} value greater than these minima can reduce the performance of the tread when used at very low temperature; for such a use, the T_{g} of the TPE with SBR and PS blocks is more preferentially still less than or equal to −10° C. Also preferentially, the T_{g} of the TPE with SBR and PS blocks is greater than −100° C.

The TPEs with SBR and PS blocks can be copolymers with a small number of blocks (less than 5, typically 2 or 3), in which case these blocks preferably have high weights of greater than 15 000 g/mol. These TPEs with SBR and PS blocks can, for example, be diblock copolymers, comprising one thermoplastic block and one elastomer block. They are often also triblock elastomers with two rigid segments connected by one flexible segment. The rigid and flexible segments can be positioned linearly, or in a star or branched configuration. Typically, each of these segments or blocks often contains at least more than 5, generally more than 10, base units (for example, styrene units and butadiene/styrene units for a styrene/SBR/styrene block copolymer).

The TPEs with SBR and PS blocks can also comprise a large number of smaller blocks (more than 30, typically from 50 to 500), in which case these blocks preferably have relatively low weights, for example from 500 to 5000 g/mol; these TPEs with SBR and PS blocks will subsequently be referred to as multiblock TPEs with SBR and PS blocks and are an elastomer block/thermoplastic block series.

According to a first variant, the TPE with SBR and PS blocks is in a linear form. For example, the TPE with SBR and PS blocks is a diblock copolymer: PS block/SBR block. The TPE with SBR and PS blocks can also be a triblock copolymer: PS block/SBR block/PS block, that is to say one central elastomer block and two terminal thermoplastic blocks, at each of the two ends of the elastomer block. Equally, the multiblock TPE with SBR and PS blocks can be a linear series of SBR elastomer blocks/thermoplastic PS blocks.

According to another variant of the invention, the TPE with SBR and PS blocks of use for the requirements of the invention is in a star-branched form comprising at least three branches. For example, the TPE with SBR and PS blocks can then be composed of a star-branched SBR elastomer block comprising at least three branches and of a thermoplastic PS block located at the end of each of the branches of the SBR elastomer block. The number of branches of the central elastomer can vary, for example, from 3 to 12 and preferably from 3 to 6.

According to another variant of the invention, the TPE with SBR and PS blocks is provided in a branched or dendrimer form. The TPE with SBR and PS blocks can then be composed of a branched or dendrimer SBR elastomer block and of a thermoplastic PS block located at the end of the branches of the dendrimer elastomer block.

### 1.1.2. Nature of the Elastomer Blocks

For the purposes of the invention, the elastomer blocks of the TPE with SBR and PS blocks may be all the elastomers of butadiene/styrene random copolymer type (SBR) known to those skilled in the art.

The fraction of SBR elastomer block in the TPE with SBR and PS blocks is within a range extending from 30% to 95%, preferentially from 40% to 92% and more preferentially from 50% to 90%.

These SBR blocks preferably have a T_{g} (glass transition temperature) measured by DSC according to standard ASTM D3418, 1999, of less than 25° C., preferentially less than 10° C., more preferentially less than 0° C. and very preferentially less than −10° C. Also preferably, the T_{g} of the SBR blocks is greater than −100° C. SBR blocks having a T_{g} of between 20° C. and −70° C., and more particularly between 0° C. and −50° C., are especially suitable.

In a well known way, the SBR block comprises a styrene content, a content of 1,2-bonds of the butadiene part and a content of 1,4-bonds of the butadiene part, the latter being composed of a content of trans-1,4-bonds and a content of cis-1,4-bonds when the butadiene part is not hydrogenated.

Preferentially, use is especially made of an SBR block having a styrene content for example within a range extending from 10% to 60% by weight, preferably from 20% to 50% by weight, and for the butadiene part, a content of 1,2-bonds within a range extending from 4% to 75% (mol %) and a content of 1,4-bonds within a range extending from 20% to 96% (mol %).

Depending on the degree of hydrogenation of the SBR block, the content of double bonds in the butadiene part of the SBR block may decrease as far as a content of 0 mol % for a completely hydrogenated SBR block.

Preferably, in the TPEs with SBR and PS blocks of use in the first layer of the laminate of the invention, the SBR elastomer block is hydrogenated such that a proportion ranging from 25 mol % to 100 mol % of the double bonds in the butadiene portion are hydrogenated. More preferentially, from 50 mol % to 100 mol % and very preferentially from 80 mol % to 100 mol % of the double bonds in the butadiene portion are hydrogenated.

Preferably, in the TPEs with SBR and PS blocks of use in the second layer of the laminate of the invention, the SBR elastomer block is hydrogenated such that a proportion ranging from 0 mol % to 80 mol % of the double bonds in the butadiene portion are hydrogenated. More preferentially, from 20 mol % to 70 mol % and very preferentially from 30 mol % to 60 mol % of the double bonds in the butadiene portion are hydrogenated.

Within the meaning of the present invention, the styrene part of the SBR may be composed of monomers selected from styrene monomers, and especially selected from the group consisting of unsubstituted styrene, substituted styrenes and mixtures thereof. Among the substituted styrenes, those selected from the group consisting of methylstyrenes (preferentially o-methylstyrene, m-methylstyrene and p-methylstyrene, alpha-methylstyrene, alpha,2-dimethylstyrene, alpha,4-dimethylstyrene and diphenylethylene), para-tert-butylstyrene, chlorostyrenes (preferentially o-chlorostyrene, m-chlorostyrene, p-chlorostyrene, 2,4-dichlorostyrene, 2,6-dichlorostyrene and 2,4,6-trichlorostyrene), bromostyrenes (preferentially o-bromostyrene, m-bromostyrene, p-bromostyrene, 2,4-dibromostyrene, 2,6-dibromostyrene and 2,4,6-tribromostyrene), fluorostyrenes (preferentially o-fluorostyrene, m-fluorostyrene, p-fluorostyrene, 2,4-difluorostyrene, 2,6-difluorostyrene and 2,4,6-trifluorostyrenes), para-hydroxystyrene and mixtures thereof will preferentially be selected.

According to a preferential embodiment of the invention, the elastomer blocks of the TPE with SBR and PS blocks have, in total, a number-average molecular weight (“Mₙ”) ranging from 25 000 g/mol to 350 000 g/mol, preferably from 35 000 g/mol to 250 000 g/mol, so as to confer, on the TPE with SBR and PS blocks, good elastomeric properties and sufficient mechanical strength compatible with the use as tyre tread.

The elastomer block can also be composed of several elastomer blocks as defined above.

### 1.1.3. Nature of the Thermoplastic Blocks

Use will be made, for the definition of the thermoplastic blocks, of the characteristic of glass transition temperature (T_{g}) of the rigid thermoplastic block. This characteristic is well known to those skilled in the art. It makes it possible especially to choose the industrial processing (transformation) temperature. In the case of an amorphous polymer (or polymer block), the processing temperature is chosen to be substantially greater than the T_{g}. In the specific case of a semicrystalline polymer (or polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference is made to “T_{g} (or M.p., if appropriate)”, it will be necessary to consider that this is the temperature used to choose the processing temperature.

For the requirements of the invention, the TPE elastomers with SBR and PS blocks comprise one or more thermoplastic block(s) preferably having a T_{g} (or M.p., if appropriate) of greater than or equal to 80° C. and composed of polymerized styrene (PS) monomers. Preferentially, this thermoplastic block has a T_{g} (or M.p., if appropriate) within a range varying from 80° C. to 250° C. Preferably, the T_{g} (or M.p., if appropriate) of this thermoplastic block is preferentially from 80° C. to 200° C., more preferentially from 80° C. to 180° C.

The fraction of thermoplastic PS block in the TPE with SBR and PS blocks is within a range extending from 5% to 70%, preferentially from 8% to 60% and more preferentially from 10% to 50%.

The thermoplastic blocks of the TPE with SBR blocks are polystyrene blocks. The preferential polystyrenes are obtained from styrene monomers selected from the group consisting of unsubstituted styrene, substituted styrenes and mixtures thereof. Among the substituted styrenes, those selected from the group consisting of methylstyrenes (preferentially o-methylstyrene, m-methylstyrene and p-methylstyrene, alpha-methylstyrene, alpha,2-dimethylstyrene, alpha,4-dimethylstyrene and diphenylethylene), para-tert-butylstyrene, chlorostyrenes (preferentially o-chlorostyrene, m-chlorostyrene, p-chlorostyrene, 2,4-dichlorostyrene, 2,6-dichlorostyrene and 2,4,6-trichlorostyrene), bromostyrenes (preferentially o-bromostyrene, m-bromostyrene, p-bromostyrene, 2,4-dibromostyrene, 2,6-dibromostyrene and 2,4,6-tribromostyrene), fluorostyrenes (preferentially o-fluorostyrene, m-fluorostyrene, p-fluorostyrene, 2,4-difluorostyrene, 2,6-difluorostyrene and 2,4,6-trifluorostyrene), para-hydroxystyrene and mixtures thereof will preferentially be selected.

Very preferentially, the thermoplastic blocks of the TPE with SBR blocks are blocks obtained from unsubstituted polystyrene.

According to a variant of the invention, the polystyrene block as defined above can be copolymerized with at least one other monomer, so as to form a thermoplastic block having a T_{g} (or M.p., if appropriate) as defined above.

By way of illustration, this other monomer capable of copolymerizing with the polymerized monomer can be selected from diene monomers, more particularly conjugated diene monomers having from 4 to 14 carbon atoms, and monomers of vinylaromatic type having from 8 to 20 carbon atoms.

According to the invention, the thermoplastic blocks of the TPE with SBR and PS blocks have, in total, a number-average molecular weight (“Mₙ”) ranging from 5000 g/mol to 150 000 g/mol, so as to confer, on the TPE with SBR and PS blocks, good elastomeric properties and sufficient mechanical strength compatible with the use as tyre tread.

The thermoplastic block can also be composed of several thermoplastic blocks as to defined above.

1.1.4. Examples of TPE with SBR and PS Blocks

By way of examples of commercially available TPE elastomers with SBR and PS blocks, mention may be made of SOE-type elastomers, sold by Asahi Kasei under the name SOE 51611, SOE L605, or else SOE L606.

1.1.5. Amount of TPE with SBR and PS Blocks in Each of the Layers

The amount of TPE with SBR and PS blocks in each of the layers of the tyre laminate is explained below in the specific description of each of the layers.

### I-2 Diene Elastomer

The thermoplastic elastomer(s) described above are sufficient in themselves for the thermoplastic elastomer layer of the multilayer laminate according to the invention to be usable; however, diene elastomers can be used in this thermoplastic elastomer layer and, in terms of the diene layer, the latter comprises more diene elastomer(s) than thermoplastic elastomer(s).

Thus, the multilayer laminate according to the invention comprises at least one (that is to say, one or more) diene elastomer, which can be used alone or as a blend with at least one (that is to say, one or more) other diene elastomer (or rubber).

The content of diene elastomer, which is or is not optional, in each of the layers of the laminate of the invention will be explained below with the specific features of each of the layers of the laminate of the invention.

“Diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”.

“Essentially unsaturated” is understood to mean generally a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood to mean in particular a diene elastomer having a content of units of diene origin (conjugated dienes) which is greater than 50%.

Thus it is that diene elastomers, such as some butyl rubbers or copolymers of dienes and of α-olefins of EPDM type, can be described as “essentially saturated” diene elastomers (low or very low content of units of diene origin, always less than 15%).

Given these definitions, diene elastomer, irrespective of the above category, capable of being used in the compositions in accordance with the invention is understood more particularly to mean:

(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, especially, 1,4-hexadiene, ethylidenenorbornene or dicyclopentadiene;
(d)—a copolymer of isobutene and of isoprene (diene butyl rubber) and also the halogenated versions, in particular chlorinated or brominated versions, of this type of copolymer.

Any type of diene elastomer can be used in the invention. When the composition comprises a vulcanization system, use is preferably made of essentially unsaturated elastomers, in particular of the (a) and (b) types above, in the manufacture of the multilayer laminate according to the present invention.

The following are especially suitable as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2, 3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can contain between 99% and 20% by weight of diene units and between 1% and 80% by weight of vinylaromatic units. The elastomers can have any microstructure, which depends on the polymerization conditions used, especially on the presence or absence of a modifying and/or randomizing agent and on the amounts of modifying and/or randomizing agent employed. The elastomers can, for example, be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). As other examples of functionalized elastomers, mention may also be made of elastomers (such as SBR, BR, NR or IR) of the epoxidized type.

### I-3. Nanometric (or Reinforcing) and Micrometric (or Non-Reinforcing) Fillers

The elastomers described above are sufficient in themselves for the multilayer laminate according to the invention to be usable; nevertheless, a reinforcing filler can be used in the composition and especially in the diene layer or second layer of the laminate of the invention.

When a reinforcing filler is used, use may be made of any type of filler usually used for the manufacture of tyres, for example an organic filler such as carbon black, an inorganic filler such as silica, or else a blend of these two types of filler, especially a blend of carbon black and silica. Preferentially, especially in the second layer, silica is used as the predominant reinforcing filler.

When a reinforcing inorganic filler is used, it is possible, for example, to use, in a known way, an at least bifunctional coupling agent (or bonding agent) intended to provide a satisfactory connection, of chemical and/or physical nature, between the inorganic filler (surface of its particles) and the elastomer, in particular bifunctional organosilanes or polyorganosiloxanes.

In the same way, the composition of the layers of the multilayer laminate of the invention can comprise one or more micrometric fillers, referred to as “non-reinforcing” or inert fillers, such as the platy fillers known to those skilled in the art.

1.4. PPE Resin

The elastomers described above are sufficient in themselves for the multilayer laminate according to the invention to be usable; nevertheless, a PPE resin can be used in the composition and especially in the thermoplastic elastomer layer of the laminate of the invention.

Thus, preferentially and especially in the first layer, the laminate according to the invention can also comprise a thermoplastic resin based on optionally substituted polyphenylene ether units (abbreviated to “PPE resin”). This type of compound is described for example in the encyclopaedia “Ullmann's Encyclopedia of Industrial Chemistry” published by VCH, vol. A 21, pages 605-614, 5th edition, 1992.

The PPE resin useable for the requirements of the invention preferentially has a glass transition temperature (T_{g}), measured by DSC according to standard ASTM D3418, 1999, within a range extending from 0 to 215° C., preferably from 5 to 200° C. and more preferentially from 5 to 185° C. Below 0° C. the PPE resin does not enable a sufficient shift of the T_{g} in the composition which comprises it and above 215° C. manufacturing problems, especially in terms of obtaining a homogeneous mixture, may be encountered.

Preferably, the PPE resin is a compound which predominantly comprises polyphenylene units of general formula (I):

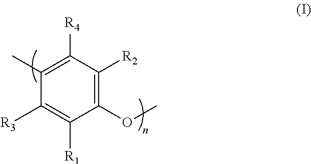

in which:

R₁, R₂, R₃ and R₄ represent, independently of one another, identical or different groups selected from hydrogen; hydroxyl, alkoxy, halogen, amino, alkylamino or dialkylamino groups; hydrocarbon-based groups comprising at least 2 carbon atoms, optionally interrupted by heteroatoms and optionally substituted; R₁ and R₃ on the one hand, and R₂ and R₄ on the other hand, possibly forming, together with the carbon atoms to which they are attached, one or more rings fused to the benzene ring of the compound of formula (I),

n is an integer within a range extending from 3 to 300.

Preferentially, R₁, R₂, R₃ and R₄ represent, independently of one another, identical or different groups selected from:

hydrogen,

hydroxyl, alkoxy, halogen, amino, alkylamino or dialkylamino groups,

linear, branched or cyclic alkyl groups, comprising from 1 to 25 carbon atoms (preferably from 2 to 18), optionally interrupted by heteroatoms selected from nitrogen, oxygen and sulphur and optionally substituted by hydroxyl, alkoxy, amino, alkylamino, dialkylamino or halogen groups,

aryl groups comprising from 6 to 18 carbon atoms (preferably from 6 to 12), optionally substituted by hydroxyl, alkoxy, amino, alkylamino, dialkylamino, alkyl or halogen groups.

More preferentially, R₁, R₂, R₃ and R₄ represent, independently of one another, identical or different groups selected from:

hydrogen,

hydroxyl groups, alkoxy groups comprising from 1 to 6 carbon atoms, halogen groups, amino groups, alkylamino groups comprising from 1 to 6 carbon atoms, or dialkylamino groups comprising from 2 to 12 carbon atoms,

linear, branched or cyclic alkyl groups, comprising from 1 to 12 carbon atoms (preferably from 2 to 6), optionally interrupted by heteroatoms and optionally substituted by hydroxyl groups, alkoxy groups comprising from 1 to 6 carbon atoms, amino groups, alkylamino groups comprising from 1 to 6 carbon atoms, dialkylamino groups comprising from 2 to 12 carbon atoms, or halogen groups,

aryl groups comprising from 6 to 18 carbon atoms (preferably from 6 to 12), optionally substituted by hydroxyl groups, alkoxy groups comprising from 1 to 6 atoms, amino groups, alkylamino groups comprising from 1 to 6 atoms, dialkylamino groups comprising from 2 to 12 carbon atoms, alkyl groups comprising from 1 to 12 carbon atoms, or halogen groups.

Even more preferentially, R₁ and R₂ represent an alkyl group and in particular a methyl group, and R₃ and R₄ represent hydrogen atoms. In this case, the PPE resin is a poly(2,6-dimethyl-1,4-phenylene ether).

Also preferentially, n is an integer within a range extending from 3 to 50, more preferentially from 5 to 30 and preferably from 6 to 20.

Preferably, the PPE resin is a compound comprising more than 80% by weight, and more preferentially still more than 95% by weight of polyphenylene units of general formula (I).

Mention may be made, as examples, of poly(2,6-dimethyl-1,4-phenylene ether) and especially Noryl SA 120 from Sabic or Xyron S202A from Asahi Kasei.

In a known way, PPE resins have, for example and preferentially, number-average molecular weights (Mₙ) which are variable, most often from 15 000 to 30 000 g/mol; in the case of high weights such as these, Mₙ is measured in a way known to those skilled in the art by SEC (also referred to as GPC, as in reference U.S. Pat. No. 4,588,806, column 8). For the requirements of the invention a PPE resin having a weight Mₙ lower than the weights usually encountered and especially lower than 6000 g/mol, preferably lower than 3500 g/mol and in particular an Mₙ within a range extending from 700 to 2500 g/mol can to also and preferentially also be used for the composition of the invention. The number-average molecular weight (Mₙ) of the PPEs with a weight lower than 6000 g/mol is measured by NMR, since the conventional SEC measurement is not precise enough. This NMR measurement is carried out in a way known to those skilled in the art, either by assaying the chain end functions or by assaying the polymerization initiators, as explained for example in “Application of NMR spectroscopy in molecular weight determination of polymers” by Subhash C. Shit and Sukumar Maiti in “European Polymer Journal” vol. 22, no. 12, pages 1001 to 1008 (1986).

The value of the polydispersity index PI (reminder: PI=M_{w}/Mₙ, with M_{w} the weight-average molecular weight and Mₙ the number-average molecular weight) of the PPE resin is preferentially less than or equal to 5, more preferentially less than or equal to 3 and more preferentially still less than or equal to 2.

The content of PPE resin in the laminate and especially in the first layer is preferentially within a range extending from 1 to 90 phr, more preferentially from 2 to 80 phr, more preferentially still from 3 to 60 phr and very preferentially from 5 to 60 phr.

### I-5. Various Additives

The multilayer laminate of the invention can furthermore comprise the various additives normally present in tyre elastomeric layers known to those skilled in the art. For example, one or more additives selected from protection agents, such as antioxidants or antiozonants, UV stabilizers, the various processing aids or other stabilizers, or else promoters capable of promoting the adhesion to the remainder of the structure of the tyre, will be chosen. Preferentially, the thermoplastic elastomer layer of the multilayer laminate does not contain all these additives at the same time and preferentially, in some cases, the thermoplastic elastomer layer of the multilayer laminate does not comprise any of these agents.

Also and optionally, the composition of the layers of the multilayer laminate of the invention can contain a crosslinking system known to those skilled in the art. Preferentially, the composition of the thermoplastic elastomer layer of the multilayer laminate does not contain a crosslinking system.

Also optionally, the composition of the layers of the multilayer laminate of the invention can contain a plasticizing agent, such as an extending oil (or plasticizing oil) or a plasticizing resin, the role of which is to facilitate the processing of the multilayer laminate, in particular its incorporation in the tyre, by lowering the modulus and increasing the tackifying power.

In addition to the elastomers described above, the compositions of the multilayer laminate can also comprise, always according to a minor fraction by weight with respect to the block elastomer, one or more (non-elastomeric) thermoplastic polymers, such as those based on polyether.

### II—MULTILAYER LAMINATE

As indicated above, the multilayer laminate of the invention thus has the essential characteristic of comprising at least two adjacent layers of elastomer:
a first layer, composed of a composition based on at least one thermoplastic elastomer (TPE), said thermoplastic elastomer being a block copolymer comprising at least one optionally hydrogenated butadiene/styrene random copolymer-type elastomer block and at least one styrene-type thermoplastic block, at a content within a range extending from more than 50 to 100 phr (parts by weight per 100 parts by weight of elastomer);
a second layer, composed of a composition based on at least one diene elastomer, the content of diene elastomer being within a range extending from more than 50 to 95 phr, and on at least one thermoplastic elastomer (TPE), said thermoplastic elastomer being a block copolymer comprising at least one optionally hydrogenated butadiene/styrene random copolymer-type elastomer block and at least one styrene-type thermoplastic block, at a content within a range extending from 5 to less than 50 phr.

### II-1. First Layer or Thermoplastic Elastomer Layer

Use is made, as first, thermoplastic elastomer, layer, of an elastomeric composition comprising more than 50 phr of TPE elastomer with SBR and PS blocks as defined above, with all the preferences for structure and chemical nature of the thermoplastic and elastomeric blocks expressed above.

The thermoplastic elastomer layer described above could optionally comprise other elastomers than the TPEs, diene elastomers, in a minor amount (at most 50 phr). Such diene elastomers are defined above and the composition of the thermoplastic elastomer layer can optionally and preferentially also comprise other components, such as those presented above and optionally in common with the second layer of the laminate of the invention. Among them there is especially the PPE resin.

Preferably, the content of TPE with SBR and PS blocks in the first layer is within a range extending from 70 to 100 phr, in particular within a range extending from 80 to 100 phr.

However, according to a particularly preferential embodiment, the TPE(s) with SBR and PS blocks are the only elastomers present in the thermoplastic elastomer layer; consequently, in such a case, at a content equal to 100 phr.

Optionally and preferentially, the first layer can optionally and preferentially also comprise other components, such as those presented above and optionally in common with the second layer of the laminate of the invention. Among them there is especially the PPE resin.

### II-2. Second Layer or Diene Layer

Use is made, as second layer, in combination with the first layer, of an elastomer composition, the essential characteristic of which is to comprise an amount varying from 5 to less than 50 phr of TPE with SBR and PS blocks, as replacement for a part of the diene elastomer. Thus, the content of diene elastomer in this second layer is between 50 and 95 phr. Below the minimum content of TPE with SBR and PS blocks, the adhesive effect is not sufficient whereas, above the recommended maximum, the properties of the diene layer are detrimentally affected to an excessive extent by the strong presence of TPE with SBR and PS blocks.

According to another preferential embodiment of the invention, the content of TPE with SBR and PS blocks (that is to say, the total content, if there are several TPEs) is within a range varying from 5 to 49 phr and more preferentially from 10 to 49 phr. Consequently, the content of diene elastomer (that is to say, the total content, if there are several of them) is preferably within a range extending from 51 to 95 phr and more preferably from 51 to 90 phr.

Optionally and preferentially, the second layer can optionally and preferentially also comprise other components, such as those presented above and optionally in common with the first layer of the laminate of the invention. Among them there is especially the reinforcing filler.

### III—ADHESION OF THE TWO LAYERS OF THE LAMINATE

It was observed that the adhesion of the first layer to the second layer in the laminate of the invention is markedly improved in comparison with the adhesion of a layer of the type of the first layer of the laminate of the invention to a conventional diene layer (that is to say, devoid of thermoplastic elastomer).

This adhesion is expressed by the compatibility of the TPEs with SBR and PS blocks present in the layers of the laminate of the invention.

### IV—USE OF THE LAMINATE IN A TYRE

The laminate of the invention can be used in any type of tyre. It is particularly well-suited to use in a tyre, tyre finished product or tyre semi-finished product made of rubber, very particularly in a tyre for a motor vehicle, such as a vehicle of two-wheel, passenger or industrial type, or a non-motor, such as a bicycle.

The laminate of the invention can be manufactured by combining the layers of the laminate before curing or even after curing. More specifically, since the thermoplastic elastomer layer does not require curing, it can be combined with the diene layer of the laminate of the invention before or after the curing of this diene layer, which itself requires curing before being used in a tyre.

The multilayer laminate of the invention can advantageously be used in pneumatic tyres of all types of vehicles, in particular in the tyres for passenger vehicles capable of running at a very high speed or the tyres for industrial vehicles, such as heavy-duty vehicles.

### V. PREPARATION OF THE LAMINATE

The multilayer laminate of the invention is prepared according to methods known to those skilled in the art, by separately preparing the two layers of the laminate and by then combining the thermoplastic elastomer layer with the diene layer, before or after the curing of the latter. The thermoplastic elastomer layer can be combined with the diene layer under the action of heat and optionally of pressure.

### V-1. Preparation of the Thermoplastic Elastomer Layer

The thermoplastic elastomer layer of the multilayer laminate of the invention is prepared conventionally, for example by incorporation of the various components in a twin-screw extruder, so as to melt the matrix and incorporate all the ingredients, followed by use of a flat die which makes it possible to produce the thermoplastic elastomer layer. More generally, the shaping of the TPE with SBR and PS blocks can be carried out by any method known to those skilled in the art: extrusion, calendering, extrusion-blow moulding, injection moulding or cast film.

### V-2. Preparation of the Diene Layer

The diene layer of the multilayer laminate of the invention is prepared in appropriate mixers, using two successive phases of preparation according to a general procedure well known to those skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the crosslinking or vulcanization system is incorporated.

According to a preferential embodiment of the invention, all the base constituents of the compositions of the invention, with the exception of the vulcanization system, such as the TPE elastomers with SBR or PS blocks, or the optional fillers, are intimately incorporated, by kneading, in the diene elastomer during the first “non-productive” phase, that is to say that at least these various base constituents are introduced into the mixer and are thermomechanically kneaded, in one or more steps, until the maximum temperature of between 130° C. and 200° C., preferably of between 145° C. and 185° C., is reached.

By way of example, the first (non-productive) phase is carried out in a single thermomechanical step during which all the necessary constituents, the optional supplementary covering agents or processing aids and various other additives, with the exception of the vulcanization system, are introduced into an appropriate mixer, such as an ordinary internal mixer. The total duration of the kneading, in this non-productive phase, is preferably between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

The final composition thus obtained is subsequently calendered, for example in the form of a layer denoted, in the present invention, diene layer.

### V-3. Preparation of the Laminate

The multilayer laminate of the invention is prepared by combining the thermoplastic elastomer layer with the diene layer, before or after curing the latter. Before curing, this consists in laying the thermoplastic elastomer layer on the diene layer to form the laminate of the invention, and in then carrying out the curing of the laminate or of the tyre provided with said laminate. After curing, the thermoplastic elastomer layer is placed on the precured diene layer. In order for adhesion to be able to be established, a temperature is needed at the interface which is greater than the processing temperature of the TPE, which is itself greater than the glass transition temperature (T_{g}) and, in the case of a semicrystalline thermoplastic block, than the melting point (M.p.) of said TPE, optionally in combination with the application of pressure.

### VI— EXAMPLES

### VI-1. Preparation of the Examples

The examples of multilayer laminate of the invention are prepared as indicated above.

### VI-2. Description of the Tests Used

The examples of multilayer laminate of the tyre of the invention are tested with regard to the adhesion of the TPE layer to the diene layer according to a “peel” test.

The peel test specimens are produced by bringing the following layers of the to laminate into contact: diene layer reinforced by a fabric (so as to limit the deformation of the said layers under tension)/TPE layer/diene layer reinforced by a fabric. In this symmetrical stack, an incipient crack is inserted between the TPE layer and one of the adjacent diene layers.

The laminate test specimen, once assembled, is brought to 160° C. under pressure for 27 minutes. Strips with a width of 30 mm were cut out using a cutting machine. The two sides of the incipient crack were subsequently placed in the jaws of a tensile testing device with the Insron® trade name. The tests are carried out at a temperature of 100° C. and at a pull rate of 100 mm/min. The tensile stresses are recorded and the latter are standardized by the width of the test specimen. A curve of strength per unit of width (in N/mm) as a function of the movable crosshead displacement of the tensile testing device (between 0 and 200 mm) is obtained. The adhesion value selected corresponds to the initiation of failure in the test specimen and thus to the maximum value of this curve. The performances of the examples are standardized with respect to the control without the TPE layer (base 100). The adhesion value is supplemented by the failure pattern or type of failure: an adhesive pattern means that the adhesive interface was the point of failure, whereas a cohesive pattern reveals cohesion of the material (diene or TPE layer) which is lower than the adhesive strength of the interface, with a point of failure within one of the layers.

### VI-3. Laminate Examples

### VI-3-1. Example 1

Firstly, a multilayer laminate thermoplastic composition and various diene layers were prepared, assembled before curing and tested as indicated above; the compositions are presented in Tables 1A and 1B below.

TABLE 1A

| Thermoplastic composition | A1 |
|---|---|
| TPE: SOE L606 - Asahi Kasei- (phr) | 100 |
| PPE resin:- Xyron S202A - Sabic (phr) | 18 |

TABLE 1B

| Diene composition | B1 | B2 | B3 |
|---|---|---|---|
| SBR (1) | 100 | 60 | 51 |
| SOE (2) | 0 | 40 | 49 |
| Carbon black (3) | 5 | 5 | 5 |
| Silica (4) | 26 | 26 | 26 |
| Coupling agent (5) | 2 | 2 | 2 |
| Antioxidant (6) | 2 | 2 | 2 |
| DPG (7) | 0.5 | 0.5 | 0.5 |
| Stearic acid (8) | 2 | 2 | 2 |
| ZnO (9) | 3 | 3 | 3 |
| Sulphur | 2 | 2 | 2 |
| Accelerator (10) | 1 | 1 | 1 |

(1) Solution SBR, copolymer of styrene and butadiene with 26.5% of styrene units and 24% of 1,2- units of the butadiene part (T_{g} of −48° C.)
(2) SOE, SOE S 1611 sold by Asahi Kasei
(3) ASTM grade N234, sold by Cabot
(4) Silica, Zeosil 1165MP from Rhodia
(5) TESTP coupling agent, Si69 from Degussa
(6) N-(1,3-Dimethylbutyl)-N′-phenyl-p-phenylenediamine, 6-PPD, from Flexsys
(7) DPG: Diphenylguanidine, Perkacit DPG from Flexsys
(8) Stearic acid, Pristerene from Uniqema
(9) Zinc oxide of industrial grade from Umicore
(10) N-Cyclohexyl-2-benzothiazolesulphenamide, Santocure CBS from Flexsys

The results presented in Table 2 demonstrate the excellent results in adhesion of the laminate according to the invention, compared with a situation in which the thermoplastic elastomer layer is combined with a conventional diene layer (that is to say, not comprising any TPE at all in its composition).

It is also noted that comparison of examples A1/B2 and A1/B3 demonstrates that, from a content of TPE with SBR and PS blocks of 40 phr upwards in the “diene” layer, the adhesion of this layer with a thermoplastic layer of TPE with SBR and PS blocks remains the same, to the extent that it is not necessary for the invention to exceed a content of 49 phr of TPE with SBR and PS blocks. On the contrary, a content of TPE with SBR and PS blocks in the diene layer of greater than 50 phr would make the thermoplastic elastomer character greater than the diene character of this layer and could reduce the adhesion of the diene layer to another adjacent diene layer.

TABLE 2

| | Multilayer laminate | | |
|---|---|---|---|
| | A1/B1 | | |
| | control | A1/B2 | A1/B3 |
| Adhesion | 100 | 260 | 280 |
| performance (%) | | | |
| Failure type | Adhesive | Cohesive | Cohesive |

1.-35. (canceled)

36. An elastomeric laminate for tires, said laminate comprising at least two superimposed layers of elastomer:
a first layer comprising a composition based on at least one thermoplastic elastomer, said thermoplastic elastomer being a block copolymer comprising at least one optionally hydrogenated butadiene/styrene random copolymer-type elastomer block and at least one styrene-type thermoplastic block, at a content within a range extending from more than 50 to 100 phr (parts by weight per 100 parts by weight of elastomer); and
a second layer comprising a composition based on at least one diene elastomer, the content of diene elastomer being within a range extending from more than 50 to 95 phr, and on at least one thermoplastic elastomer, said thermoplastic elastomer being a block copolymer comprising at least one optionally hydrogenated butadiene/styrene random copolymer-type elastomer block and at least one styrene-type thermoplastic block, at a content within a range extending from 5 to less than 50 phr.

37. The laminate according to claim 36, wherein the number-average molecular weight of the at least one thermoplastic elastomer is between 30,000 and 500,000 g/mol.

38. The laminate according to claim 36, wherein the at least one elastomer block of the at least one thermoplastic elastomer is selected from elastomers having a glass transition temperature of less than 25° C.

39. The laminate according to claim 36, wherein the at least one elastomer block has a styrene content within a range extending from 10% to 60%.

40. The laminate according to claim 36, wherein the at least one elastomer block has a content of 1,2-bonds for the butadiene part within a range extending from 4 mol % to 75 mol % and a content of 1,4-bonds within a range extending from 20 mol % to 96 mol %.

41. The laminate according to claim 36, wherein the at least one elastomer block of the first layer is hydrogenated such that a proportion extending from 25 mol % to 100 mol % of the double bonds in the butadiene portion are hydrogenated.

42. The laminate according to claim 41, wherein the at least one elastomer block is hydrogenated such that a proportion extending from 50 mol % to 100 mol % of the double bonds in the butadiene portion are hydrogenated.

43. The laminate according to claim 42, wherein the at least one elastomer block is hydrogenated such that a proportion extending from 80 mol % to 100 mol % of the double bonds in the butadiene portion are hydrogenated.

44. The laminate according to claim 36, wherein the at least one elastomer block of the second layer is hydrogenated such that a proportion extending from 0 to 80 mol % of the double bonds in the butadiene portion are hydrogenated.

45. The laminate according to claim 44, wherein the at least one elastomer block is hydrogenated such that a proportion extending from 20 mol % to 70 mol % of the double bonds in the butadiene portion are hydrogenated.

46. The laminate according to claim 45, wherein the at least one elastomer block is hydrogenated such that a proportion extending from 30 mol % to 60 mol % of the double bonds in the butadiene portion are hydrogenated.

47. The laminate according to claim 36, wherein the at least one thermoplastic block of the block copolymer is selected from polymers having a glass transition temperature of greater than 80° C. and, in the case of a semicrystalline thermoplastic block, a melting point of greater than 80° C.

48. The laminate according to claim 36, wherein the fraction of the at least one thermoplastic block in the block copolymer is within a range extending from 5% to 70%.

49. The laminate according to claim 36, wherein the at least one thermoplastic block of the block copolymer is selected from polystyrenes.

50. The laminate according to claim 49, wherein the at least one thermoplastic block of the block copolymer is selected from polystyrenes obtained from styrene monomers selected from the group consisting of unsubstituted styrene, methylstyrenes, para-tert-butylstyrene, chlorostyrenes, bromostyrenes, fluorostyrenes, para-hydroxystyrene and mixtures thereof.

51. The laminate according to claim 50, wherein the at least one thermoplastic block of the block copolymer are selected from polystyrenes obtained from styrene monomers selected from the group consisting of unsubstituted styrene, o-methylstyrene, m-methylstyrene, p-methylstyrene, alpha-methyl styrene, alpha,2-dimethyl styrene, alpha,4-dimethyl styrene, diphenylethylene, para-tert-butyl styrene, o-chlorostyrene, m-chlorostyrene, p-chlorostyrene, 2,4-dichlorostyrene, 2,6-dichlorostyrene, 2,4,6-trichlorostyrene, o-bromostyrene, m-bromostyrene, p-bromostyrene, 2,4-dibromostyrene, 2,6-dibromostyrene, 2,4,6-tribromostyrene, o-fluorostyrene, m-fluorostyrene, p-fluorostyrene, 2,4-difluorostyrene, 2,6-difluorostyrene, 2,4,6-trifluorostyrene, para-hydroxystyrene and mixtures thereof.

52. The laminate according to claim 51, wherein the at least one thermoplastic block of the block copolymer is obtained from unsubstituted polystyrene.

53. The laminate according to claim 36, wherein the content of the at least one thermoplastic elastomer in the composition of the first layer is within a range extending from 70 to 100 phr.

54. The laminate according to claim 53, wherein the content of the at least one thermoplastic elastomer in the composition of the first layer is within a range extending from 80 to 100 phr.

55. The laminate according to claim 36, wherein the at least one thermoplastic elastomer is the only elastomer of the first layer.

56. The laminate according to claim 36, wherein the first layer does not contain a crosslinking system.

57. The laminate according to claim 36, wherein the first layer additionally comprises a thermoplastic resin comprising optionally substituted polyphenylene ether units.

58. The laminate according to claim 57, wherein the thermoplastic resin comprising optionally substituted polyphenylene ether units has a glass transition temperature T_{g}, measured by DSC according to Standard ASTM D3418, 1999, within a range extending from 0 to 215° C.

59. The laminate according to claim 57, wherein the thermoplastic resin comprising optionally substituted polyphenylene ether units is a compound comprising predominantly polyphenylene units of general formula (I): 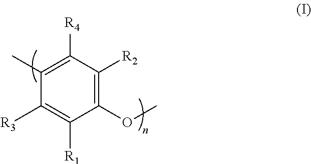
in which:
R₁, R₂, R₃ and R₄ represent, independently of one another, identical or different groups selected from hydrogen, hydroxyl, alkoxy, halogen, amino, alkylamino or dialkylamino groups or hydrocarbon-based groups comprising at least 2 carbon atoms, optionally interrupted by heteroatoms and optionally substituted; R₁ and R₃ on the one hand, and R₂ and R₄ on the other hand, possibly forming, together with the carbon atoms to which they are attached, one or more rings fused to the benzene ring of the compound of formula (I), and
n is an integer within a range extending from 3 to 300.

60. The laminate according to claim 59, wherein R₁ and R₂ represent an alkyl group and R₃ and R₄ represent hydrogen atoms.

61. The laminate according to claim 60, wherein R₁ and R₂ represent a methyl group.

62. The laminate according to claim 57, wherein the content of said thermoplastic resin comprising optionally substituted polyphenylene ether units is within a range extending from 1 to 90 phr.

63. The laminate according to claim 62, wherein the content of said thermoplastic resin comprising optionally substituted polyphenylene ether units is within a range extending from 2 to 80 phr.

64. The laminate according to claim 63, wherein the content of said thermoplastic resin comprising optionally substituted polyphenylene ether units is within a range extending from 3 to 60 phr.

65. The laminate according to claim 64, wherein the content of said thermoplastic resin comprising optionally substituted polyphenylene ether units is within a range extending from 5 to 60 phr.

66. The laminate according to claim 36, wherein the content of the at least one thermoplastic elastomer in the composition of the second layer is within a range extending from 5 to 49 phr.

67. The laminate according to claim 66, wherein the content of the at least one thermoplastic elastomer in the composition of the second layer is within a range extending from 10 to 49 phr.

68. The laminate according to claim 36, wherein the at least one diene elastomer of the second layer is selected from the group consisting of essentially unsaturated diene elastomers and mixtures thereof.

69. The laminate according to claim 68, wherein the at least one diene elastomer is selected from the group consisting of homopolymers obtained by polymerization of a conjugated diene monomer having from 4 to 12 carbon atoms, copolymers obtained by copolymerization of one or more conjugated dienes with one another or with one or more vinylaromatic compounds having from 8 to 20 carbon atoms, and mixtures thereof.

70. The laminate according to claim 69, wherein the at least one diene elastomer is selected from the group consisting of polybutadienes, synthetic polyisoprenes, natural rubber, butadiene copolymers, isoprene copolymers and the mixtures thereof.

71. The laminate according to claim 36, wherein the second layer further comprises a reinforcing filler.

72. The laminate according to claim 71, wherein the reinforcing filler is carbon black, silica, or a mixture of carbon black and silica.

73. The laminate according to claim 72, wherein the predominant reinforcing filler is silica.

74. A tire comprising a laminate according to claim 36.

75. A method of making a pneumatic object comprising the step of incorporating a laminate according to claim 36.
